(19) United States
(12) Patent Application Publication
(10) Pub. No.: US 2024/0422581 A1
(43) Pub. Date: Dec. 19, 2024

(54) ENHANCEMENTS FOR LIGHTWEIGHT EXTENSIBLE REMOTE COMMUNICATIONS SYSTEM

(71) Applicants: James L. Gilbert, Lenexa, TX (US); Nicholas T. Agnew, Lenexa, TX (US); Auston W. Jacobsen, Lenexa, TX (US)

(72) Inventors: James L. Gilbert, Lenexa, TX (US); Nicholas T. Agnew, Lenexa, TX (US); Auston W. Jacobsen, Lenexa, TX (US)

(21) Appl. No.: 18/670,232

(22) Filed: May 21, 2024

Related U.S. Application Data
(63) Continuation-in-part of application No. 18/257,970, filed on Jun. 16, 2023.

(51) Int. Cl. H04W 24/02; H04W 88/08

(52) U.S. Cl. CPC H04W 24/02; H04W 88/08

(57) ABSTRACT

An embodiment of the present invention relates to improvements in a rapidly deployable communication system, addressing limitations of existing solutions in remote and austere environments.

This improved communication system offers a more user-friendly, highly portable, and highly scalable solution for reliable communication in remote and challenging environments. The ultra-lightweight design and enhanced uplink connectivity options make it ideal for situations where portability and network flexibility are paramount, catering to a wider range of user demands in diverse applications.

### CROSS-REFERENCE TO RELATED APPLICATIONS

This application claims priority to the PCT application titled ‘Remote communications system and method,’ with application U.S. Non-provisional application Ser. No. 18/257,970, which in turn claims priority to U.S. Provisional Patent Application No. 63/127,500, filed on Dec. 18, 2020. The entirety of both applications is incorporated herein by reference.

### BACKGROUND

Challenge: Delivering robust and adaptable communication solutions in remote and logistically challenging environments remains a persistent issue. Conventional systems often exhibit limitations in:

Deployment Complexity: Establishing and configuring equipment can be a cumbersome undertaking, particularly for non-technical users.

Portability Constraints: Excessive weight and volume hinder the system's mobility and rapid deployment in remote areas.

Limited Scalability: Expanding the communication network to encompass additional clients or a broader geographical area frequently necessitates significant supplementary equipment and specialized expertise.

Restricted User Capacity: Existing solutions often face limitations on the number of users they can effectively support, hindering their utility in scenarios requiring extensive coverage.

Need: There is a pressing need for a communication system that overcomes these limitations by offering:

Ease of deployment: Streamlined setup process, ideally even for non-technical personnel.

Enhanced portability: Lightweight and compact design for effortless transportation and deployment.

Scalability: Modular design allowing for easy expansion to cover larger areas and accommodate more users.

Increased user capacity: Ability to support a significantly higher number of users compared to existing solutions.

Solution: This continuation-in-part application introduces significant improvements to the communication system disclosed in International Application No. PCT WO2022132925A1, filed on Jun. 23, 2022, specifically addressing the limitations mentioned above. The proposed enhancements aim to deliver a communication system that is:

User-friendly: Designed for simple and rapid deployment, even in challenging environments.

Highly portable: Lightweight and compact for easy transportation and setup.

More rugged: Weatherproof and thermally insulated to withstand harsh environmental conditions.

Highly scalable: Modular architecture enables seamless expansion to meet growing needs.

Capable of supporting a larger number of users: Accommodates a wider range of user demands in various applications.

By addressing these critical aspects, the improved communication system presented in this application aims to provide a more robust, versatile, and user-friendly solution for diverse communication needs in remote and challenging environments.

### SUMMARY OF INVENTION

This Continuation-in-Part (CIP) application introduces significant improvements to a rapidly deployable communications system, specifically addressing limitations encountered in remote and austere environments. The original system, disclosed in International Application No. PCT WO2022132925A1, is enhanced to provide a more user-friendly, highly portable, and highly scalable solution for reliable communication.

### Key Improvements:

Simplified Deployment: The improved system prioritizes ease of use. The streamlined setup process allows for efficient deployment, even by users with limited technical expertise.

Ultra-Lightweight Design: The base station (PCL) weighs approximately 12 pounds and the distribution module (DM) weighs less than 5 pounds. This ultra-lightweight design facilitates effortless transportation, setup, and use in remote locations.

Enhanced Scalability: The modular architecture enables seamless expansion of the communication network. Additional distribution modules can be easily integrated to cover larger areas and accommodate a significantly higher number of users and a wider array of connected compared to existing solutions.

Increased Security: The base station incorporates a network module implementing firmware-based authentication protocols and encrypts data communication using industry-standard encryption algorithms. Additionally, a network security appliance is integrated for enhanced system security. Secure communication channels are established between network modules and distribution modules using firmware-based authentication.

### Overall Benefits

By addressing the critical limitations of existing communication solutions, this improved system offers several advantages:

User-friendliness: Enables rapid deployment in challenging environments, even by non-technical users.

Enhanced Portability: The ultra-lightweight design makes it ideal for situations where portability is a major concern.

Scalability: The modular architecture allows for easy expansion to meet growing user needs and cover wider areas.

Increased User Capacity: Supports a significantly larger number of users compared to existing solutions.

Improved Security: Secure communication protocols and a network security appliance enhance overall system security.

This improved communication system is well-suited for diverse applications in remote and challenging environments, catering to a wider range of user demands where reliable and secure communication is essential.

### BRIEF DESCRIPTION OF THE DRAWINGS

FIG. 1 illustrates a block diagram of the base station system according to the invention. The figure depicts the various communication options available for uplink connectivity, the internal components of the base station, and the software and security layers that manage the system's operation. It also highlights the connections between the base station and the available uplink options.

FIG. 2. depicts a simplified version the base station, also known as in some embodiments as the Portable Communications Link (PCL).

FIG. 2 illustrates the typical operational flow of the base station system (PCL) according to some embodiments of the present disclosure. The flowchart depicts the sequence of events that occur upon system startup, firmware execution, security checks, software loading and execution, user interaction, data processing, and ongoing operation.

FIG. 3 is a block diagram illustrating the presently disclosed invention as well as a Distribution Module (DM) and its connections to various user devices in the communication system. It depicts the power supply for the PCL and DM, wireless and wired connections to user devices and showcases examples of wireless user devices (laptops, VoIP phones, cellular devices) and wired user devices (IoT devices, VoIP phones, IP phones, cameras, printers, POS systems, NAS devices, gaming servers/controllers) that can connect to the network through the DM.

### DETAILED DESCRIPTION OF THE DRAWINGS

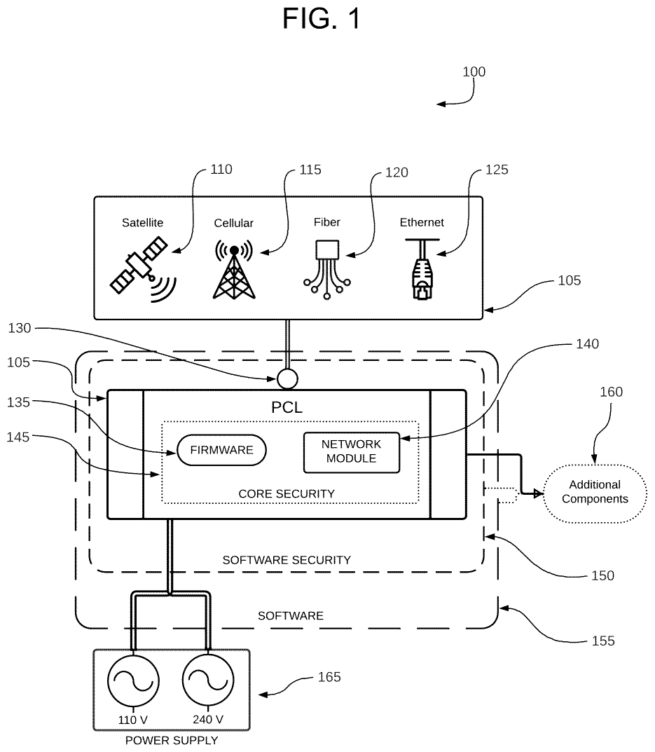

FIG. 1 is a block diagram illustrating the system according to one embodiment of the present invention. The figure details the uplink connectivity options, the internal components of the base station (PCL), the connections between the PCL and the uplink options, and the software and security architecture that manages the system's operation.

### Elements:

The system comprises a base station unit (PCL) (105) configured to establish communication with a network. The PCL (105) allows for uplink connectivity through various options presented in a dedicated box (105). These uplink connectivity options include:

110: Satellite: This element signifies the ability for the PCL to connect to the system via a satellite network.

115: Cellular Connection: This element signifies the ability for the PCL to connect to the system using a cellular network utilizing any of the following 3/4/5/6G network protocols.

120: Fiber Optic Connection: This element signifies the ability for the PCL to connect to the system using a fiber optic cable.

125: Ethernet Connection: This element signifies the ability for the PCL to connect to the system using an ethernet cable.

The PCL (105) houses several internal components. These components include:

130: PCL Connections to Uplink Options: This element represents the physical connections or interfaces within the PCL that enable communication with the chosen uplink option (satellite, cellular, fiber optic, or ethernet), according to some embodiments of the present disclosure.

135: Firmware: This element represents the embedded software that controls the core functionalities of the PCL hardware.

140: Network Module: This element represents the hardware component responsible for managing network communication through the chosen uplink option.

145: Core Security (Firmware Based): This element signifies the security functionalities implemented within the firmware to ensure the secure operation of the PCL.

150: Software Security: This dashed box represents the software layer that provides additional security measures on top of the core security features embedded in the firmware.

155: Software: This dashed box represents the software layer that manages the overall operation of the system, including network communication protocols, user interaction, and data processing.

160: Additional Components: This dotted box represents the potential for additional components to be integrated with the system, such as distribution modules (DMs) or another base station (PCL). The software and security layers (150 & 155) extend to manage these additional components as well.

### Functionality

The system allows for versatility in establishing uplink connections through various options like satellite, cellular, fiber optic, or ethernet. The PCL (105) establishes connections to the chosen uplink option through the dedicated interfaces or pathways represented by element 130 (PCL Connections to Uplink Options). The network module (140) within the PCL then utilizes these connections to manage communication with the chosen network (satellite, cellular, fiber optic, etc.). The core security features embedded within the firmware (145) ensure a secure foundation for system communication. Additional security functionalities are provided by the software security layer (150) working in conjunction with the firmware security. The software layer (155) manages the overall operation, including communication protocols, user interaction, and data processing. The system can potentially integrate with additional components (160) that are also managed by the software and security layers.

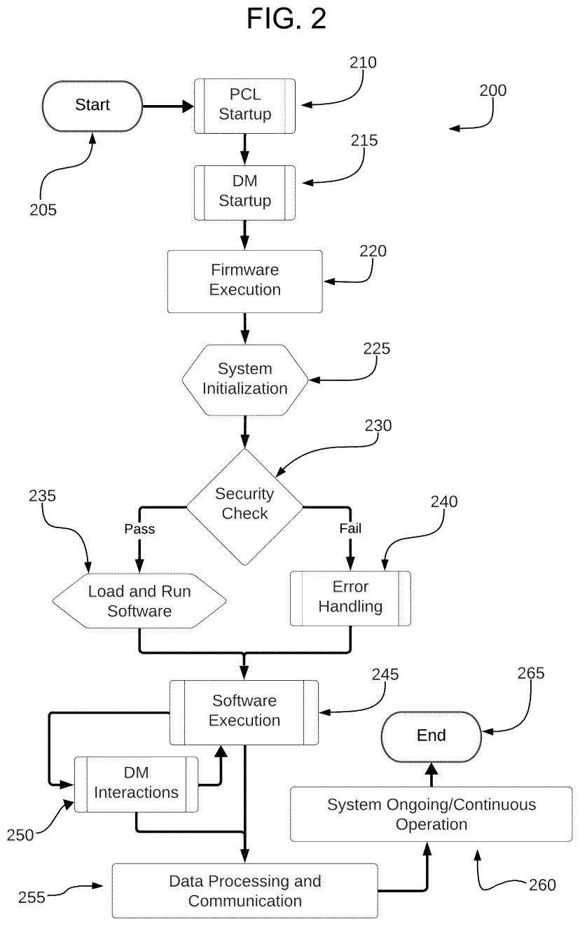

FIG. 2 illustrates the typical operational flow of the base station system (PCL) according to some embodiments of the present disclosure. The flowchart depicts the sequence of events that occur upon system startup, firmware execution, security checks, software loading and execution, user interaction, data processing, and ongoing system operation.

Flowchart elements: UPDATE FOR NEW FIG (check!)

205: Start: This element represents the initial entry point of the system, signifying the powering on of the PCL.

210: PCL Startup: This element signifies the initiation of the boot process, where the PCL hardware begins executing the firmware.

215: DM Startup: This element signifies the initiation of the boot process, where the DM hardware begins executing the firmware.

220: Firmware Execution: An arrow leads from “DM Startup” to “Firmware Execution”. This element represents the firmware taking control and performing essential tasks such as:

Initializing and testing the hardware components within the PCL (referencing element 105: PCL Box in FIG. 1).

Allocating memory resources.

Establishing a basic operating environment.

225: System Initialization: An arrow leads from “Firmware Execution” to “System Initialization”. This element represents the firmware performing additional setup tasks, such as:

Configuring communication interfaces (potentially related to element 130: PCL Connections to Uplink Options in FIG. 1).

Loading initial configuration settings.

Preparing the system for software execution.

230: Security Check: An arrow leads from “System Initialization” to a diamond-shaped decision point labeled “Security Check”. This element represents the firmware performing security checks to ensure system integrity. These checks might involve:

Verifying the authenticity and integrity of the software image stored on the PCL.

Communicating with a remote server for secure updates or configuration (utilizing the network module, element 140: Network Module in FIG. 1).

Pass Branch (Security Check Passed): If the security check passes, an arrow leads from “Security Check” (Yes branch) to a box labeled “Load and Run Software” (235). This indicates that the firmware has verified the software's integrity and proceeds to the next step.

Fail Branch (Security Check Failed): If the security check fails, an arrow leads from “Security Check” (No branch) to a box labeled “Error Handling” (240). This element represents actions taken by the firmware in case of a security breach, such as:
Displaying an error message on a connected device.
Entering a secure lockdown mode to prevent unauthorized access.
Attempting to download and install a recovery image to restore the system's security.

235: Load and Run Software: An arrow leads from the Pass branch of the “Security Check” to “Load and Run Software”. This element signifies the firmware loading the authorized software from secure storage and initiating its execution.

245: Software Execution: An arrow leads from “Load and Run Software” to “Software Execution”. This element represents the software taking control of the system and performing its primary functions, which could involve:

Establishing and managing network connections (utilizing the network module, element 140: Network Module in FIG. 1).
Monitoring and controlling connected devices.
Providing user interface functionalities for interaction.

250: DM Interactions: An arrow leads from “Software Execution” to “DM Interactions”. This element represents the DM interacting with the system through a physical interface or a remote connection. DM interactions can involve actions like configuration changes, data transfer, or system monitoring.

255: Data Processing and Communication: An arrow leads from either “DM Interactions” or “Software Execution” (depending on the flow) to “Data Processing and Communication”. This element represents the software processing DM inputs, sensor data, or other information received through various communication channels. The software might also communicate with external systems based on user interaction or system events.

260: System Ongoing/Continuous Operation: An arrow leads from “Data Processing and Communication” to “System Ongoing/Continuous Operation”. This element signifies the ongoing operation of the PCL. The software continues to execute, interacting with the firmware as needed based on user input, system events, or data processing requirements.

265: End: This element represents the system remaining in a continuous operational state, ready to respond to user interactions and system events.

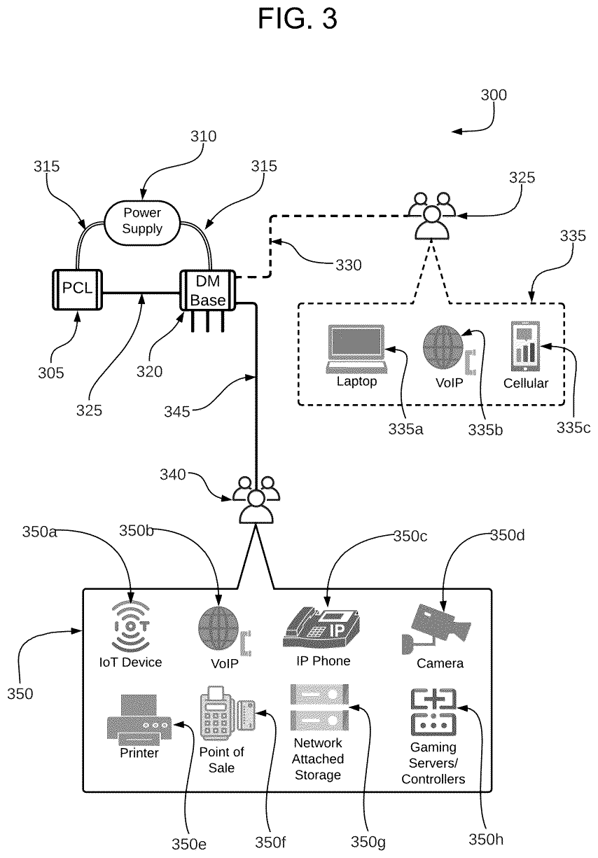

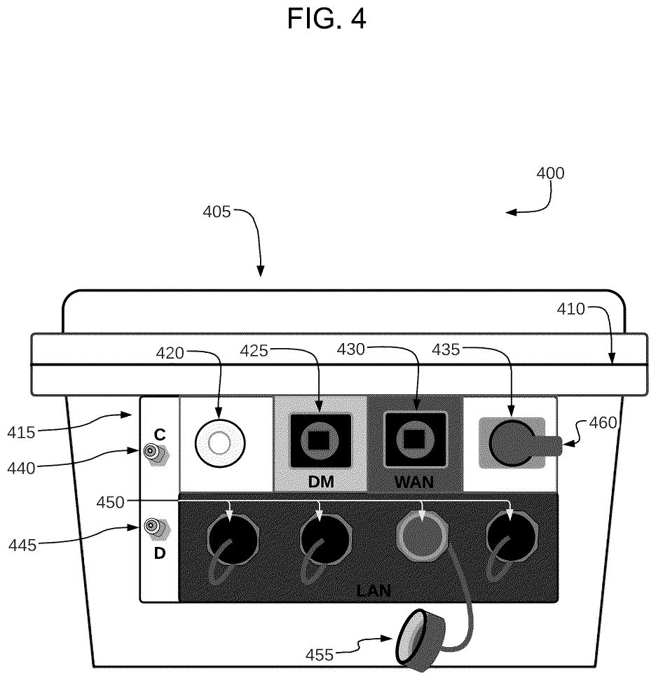

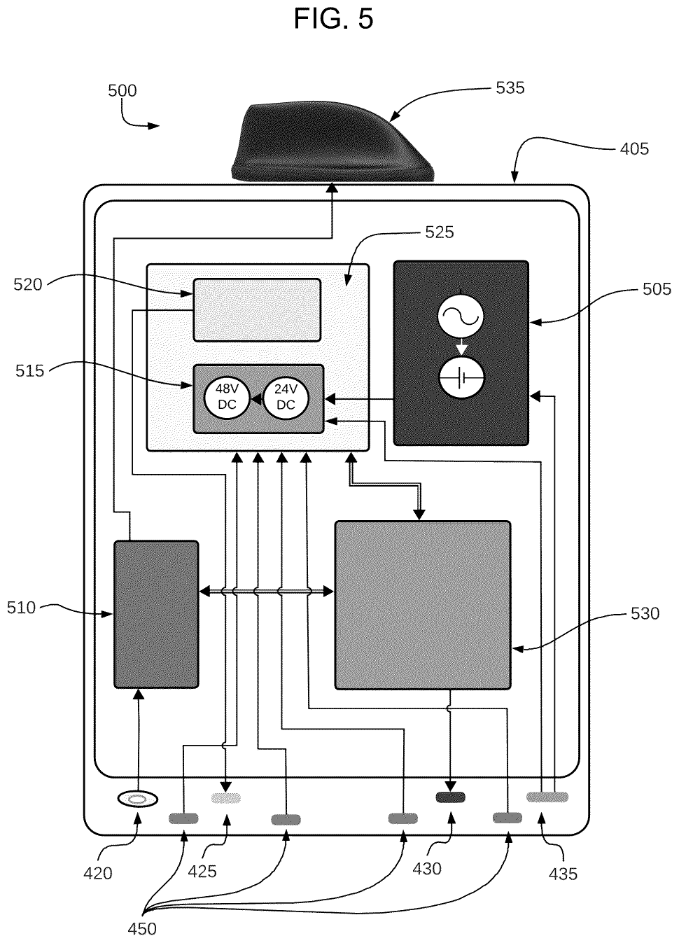

FIG. 3 depicts a block diagram illustrating the Distribution Module (DM) and how it facilitates connections for various user devices within a communication system according to one embodiment of the invention. The DM (320) receives power from an external power supply (310) through a potentially shared power connection (315) that may also supply the base station unit (PCL, 305). This PCL is depicted in a separate block, but it works together with the DM to offer network connectivity to user devices in the overall system (refer to FIG. 1 for a detailed description of the PCL).

The DM (320) connects to a group of users (325) through a wireless connection. Wireless connections (330) allow devices like laptops (335a), wireless VoIP phones (335b), and cellular devices (335c) to connect to the network.

Wired connections (345) further expand the range of compatible user devices. These can include Internet of Things (IoT) devices (350a), wired VoIP phones (350b), IP phones specifically designed for network voice communication (350c), security cameras (350d), network-connected printers (350e), Point of Sale (POS) systems (350f) for transaction processing, Network Attached Storage (NAS) devices offering high-capacity data storage (350g), and even gaming servers or controllers (350h) for online gaming applications.

FIG. 4 (400) illustrates the exterior view of a communication link (PCL) enclosure designed for rugged outdoor deployments according to some embodiments of the present disclosure. The enclosure features an IP67-rated case (405) for superior dust and water resistance, measuring approximately 13.74 inches×9.82 inches×5.88 inches. The core components are housed within utilizing a mechanically-operated water-tight seal (410) to further protected by a rubber gasket for enhanced weatherproofing.

### User-Friendly Labeling:

A key feature of the PCL enclosure is the user-friendly connector label plate (415). This plate clearly identifies each connection point (e.g., SIM card slot, DM ethernet connector, WAN receptacle) simplifying installation and maintenance for users with varying levels of technical expertise.

### Secure and Weatherproof Connections:

The PCL enclosure prioritizes secure and weatherproof connections according to some embodiments of the present disclosure. This is achieved through a variety of connectors designed for durability and ease of use:

SIM Card Slot (420): This slot features a dedicated water-tight protective housing to safeguard the SIM card from moisture and other environmental hazards.

DM Ethernet Connector (425): This connector utilizes a push-pull locking mechanism, ensuring a solid and reliable connection for data transmission with the Distribution Module (DM).

WAN Receptacle (430): This receptacle features a twist-lock lid, providing a secure and weatherproof connection for Wide Area Network (WAN) access.

Power Connector (435): This power connector can accept and auto-sense AC voltage between 110 and 240, or accept DC voltages 12/24/48 offering flexibility for global deployments.

Cellular Antenna Connectors (440 & 445): Dedicated connectors exist for both the high-gain cellular antenna (440) and its diversity antenna (445), facilitating optimal cellular signal reception.

LAN Connectors (450): Four LAN connectors provide network connectivity for various devices. Each connector boasts a watertight screw-cap for added protection against moisture ingress.

Specialty Waterproof Twist-Cap (455): This unique cap offers an additional waterproof connection point, equipped with a gasket for enhanced sealing. Notably, the cap comes attached to a cap-leash to prevent accidental loss during deployment or maintenance.

Power Watertight Hingecap (460): This hinge cap provides secure and weatherproof access to the power connector, ensuring the integrity of the enclosure even when the cap is open.

### Combined Functionality:

The combination of a robust IP67-rated case, user-friendly labeling, and secure weatherproof connectors enables the PCL enclosure to function reliably in challenging outdoor environments, simplifying deployment and maintenance for users according to some embodiments of the present disclosure.

FIG. 5 depicts the interior layout of the communication link (PCL) enclosure, showcasing the various electronic components that enable its functionality. The enclosure utilizes an IP67-rated case (reference 405 from FIG. 4) for superior dust and water resistance, ensuring reliable operation in challenging outdoor environments.

### Power Supply and Connectivity:

Power Transformer (505): This component converts incoming AC power (ranging from 110 to 240 Volts AC) to a stable 24 Volts DC (Direct Current) output. This DC voltage provides the primary power source for the internal electronics within the PCL enclosure.

Cellular Modem (510): This module facilitates cellular communication for the PCL enclosure. It translates data between the internal network and the cellular network, enabling the PCL to transmit and receive information wirelessly.

24V DC-48V DC Converter (515): This converter steps up the voltage from the power transformer's 24V DC output to 48V DC when the system is supplied with AC power. For DC power input, the connection routes directly to the transformer (515). This higher voltage is often required to power certain network devices such as the PoE injector (Power over Ethernet injector).

PoE Injector (520): The Power over Ethernet injector combines data and power into a single cable for connected devices. This eliminates the need for a separate power supply for these devices, simplifying installation and reducing cabling complexity.

Network Switch (525): This device functions as a central hub for wired network connections within the PCL enclosure. It allows multiple devices to communicate with each other by forwarding data packets efficiently. The switch may be of type “unmanaged” or managed, according to some embodiments of the present disclosure, and offers a simple and cost-effective solution for basic and advanced network needs.

Network Firewall (530): This security device acts as a gatekeeper for the PCL enclosure's network, controlling incoming and outgoing traffic. It filters and monitors network activity to protect the system from unauthorized access and malicious attacks.

### Cellular Antenna (535):

The figure depicts a cellular “shark-fin” antenna mounted on the exterior of the PCL enclosure (405). This antenna design combines multiple separate antennas into a single unit, facilitating reception of cellular signals across multiple frequency bands. This allows the PCL to maintain a strong and reliable cellular connection in a wider range of environments.

### Connection Points (420, 425, 430, 435, 450):

Along the bottom of FIG. 5, interval views showcase the connector ports situated on the enclosure's exterior (previously detailed in FIG. 4). These connectors provide access for various external devices and services:

SIM Card Slot (reference 420 from FIG. 4): This slot houses a Subscriber Identity Module (SIM) card, which identifies the PCL on the cellular network and enables billing for data usage.

DM Ethernet Connector (reference 425 from FIG. 4): This port facilitates a wired connection to the Distribution Module (DM), enabling data exchange between the PCL and the core network infrastructure.

WAN Receptacle (reference 430 from FIG. 4): This connector provides a secure and weatherproof connection for a Wide Area Network (WAN) cable, offering an alternative wired backhaul option to cellular connectivity.

AC Power Connector (reference 435 from FIG. 4): This power connector allows for connection to an external AC or DC power sources, providing the primary power supply for the entire PCL system.

LAN Connectors (reference 450 from FIG. 4): Four LAN (Local Area Network) connectors enable wired network connections for various user devices within the PCL's operational area.

By integrating these various components, the PCL enclosure functions as a robust and versatile communication hub, facilitating reliable data transmission and network connectivity in challenging outdoor environments.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A rapidly deployable and extensible communications system comprising:
a first base station (PCL) comprising:
a ruggedized container;
a distribution module (DM) removably connectable to the PCL having a first wireless communication device;
a network module securely mounted in the ruggedized container communicatively coupled with the distribution module, wherein the network module comprises:
a cellular backhaul having a cellular modem coupled in communication with a cellular network for providing a first internet source;
a network switch;
a network security appliance communicatively coupled with the cellular modem and the network switch, wherein the network security appliance is located between the cellular modem and the network switch and wherein data communications between the cellular modem and the network switch pass through the network security appliance;
a processor wherein the firmware stored on the processor is configured for:
establishing secure communication channels between the network module and the DM using one or more authentication protocols; and
encrypting data communication between the network module and the DM using on or more encryption algorithms.

2. The system of claim 1, wherein the firmware further comprises instructions for displaying a user interface on a display device and wherein the user interface is configured to facilitate user interaction for configuration, monitoring, and troubleshooting of the base station functionalities.

3. The system of claim 1, further comprising a simplified setup process for establishing communication between the base station and the DM.

4. The system of claim 1, wherein the ruggedized container is constructed from lightweight, high-strength materials configured to provide protection for the internal components while minimizing the overall weight of the base station.

5. The system of claim 1, wherein the base station weighs approximately 12.4 pounds.

6. The system of claim 1, wherein the ruggedized container is weatherproof to withstand exposure to extreme temperatures ranging from approximately-40° F. to +185° F.

7. The system of claim 1, wherein the ruggedized container is a sealed enclosure configured to protect internal components from humidity ingress.

8. The system of claim 1, wherein the network module is further configured to receive a first internet source via a user-selectable uplink connection option chosen from at least one of:
a wired WAN/LAN connection;
a cellular network connection utilizing any of the following 3/4/5/6G network protocols;
a fiber optic connection;
a satellite connection, such as a Ka or Ku Band satellite connection; or
a point-to-point radio backhaul connection.

9. The system of claim 1, wherein the base station is further configured to receive power from a user-selectable external power source chosen from at least one of:
110/240 VAC power source.
a portable generator providing 110/240 VAC or 12 VDC; or
a 12/24/36 VDC solar or wind power source.

10. The system of claim 1, wherein the firmware further comprises instructions for enabling remote monitoring, support, and administration of the base station functionalities through a secure communication network.
